(19) United States
(12) Patent Application Publication
(10) Pub. No.: US 2005/0135759 A1
(43) Pub. Date: Jun. 23, 2005

(54) Optical fiber assembly

(76) Inventors: Xingwu Wang, Wellsville, NY (US); Samuel DiVita, West Long Branch, NJ (US); Howard Greenwald, Rochester, NY (US)

Correspondence Address: HOWARD J. GREENWALD P.C., 349 W. COMMERCIAL STREET SUITE 2490, EAST ROCHESTER, NY, 14445-2408, US

(21) Appl. No.: 10/744,543

(22) Filed: Dec. 22, 2003

(51) Int. Cl. G02B 6/02

(52) U.S. Cl. 385/123

(57) ABSTRACT

A fiber assembly comprised of nanoparticles, wherein said nanoparticles are a mixture of nanomagnetic particles and nanooptical particles.

### STATEMENT REGARDING FEDERALLY SPONSORED RESEARCH AND DEVELOPMENT

One of the coinventors of this patent application, Samuel DiVita, has worked for the United States Government in various capacities since 1942. Thus, the United States Government will have rights in this patent application.

### FIELD OF THE INVENTION

An optical fiber assembly comprised of nanoparticles.

### BACKGROUND OF THE INVENTION

Optical fibers are amorphous glass assemblies that typically contain one functional material adapted to transmit light. It is an object of this invention to provide an optical fiber assembly that has several functionalites in addition to the transmission of light.

### SUMMARY OF THE INVENTION

In accordance with this invention, there is provided a fiber assembly comprised of nanoparticles, wherein said nanoparticles are a mixture of nanomagnetic particles and nanooptical particles.

### BRIEF DESCRIPTION OF THE DRAWINGS

The invention will be described by reference to the following Figures, in which like numerals refer to like elements, and in which:

FIG. 1 is

### DESCRIPTION OF THE PREFERRED EMBODIMENTS

FIGS., 1, 2, 3, and 4 are each a sectional view of one preferred fiber assembly of the invention;

FIGS. 5 and 6 illustrate applications of one preferred fiber assembly of the Invention;

FIG. 7 is a schematic of an optical isolator using Faraday rotation;

FIGS. 8A, 8B, and 8C illustrate the use spintronics with one preferred fiber assembly of the invention;

FIG. 9 is a schematic of a fiber optical device comprised of nanoparticles;

FIG. 10 is a schematic of a surface accoustic wave (SAW) device;

FIG. 11 is a schematic of an optical device with two parallel assemblies; and

FIG. 12 is a flow diagram illustrating one preferred process of the invention.

### DESCRIPTION OF THE PREFERRED EMBOIDMENTS

A Nanosized Cluster

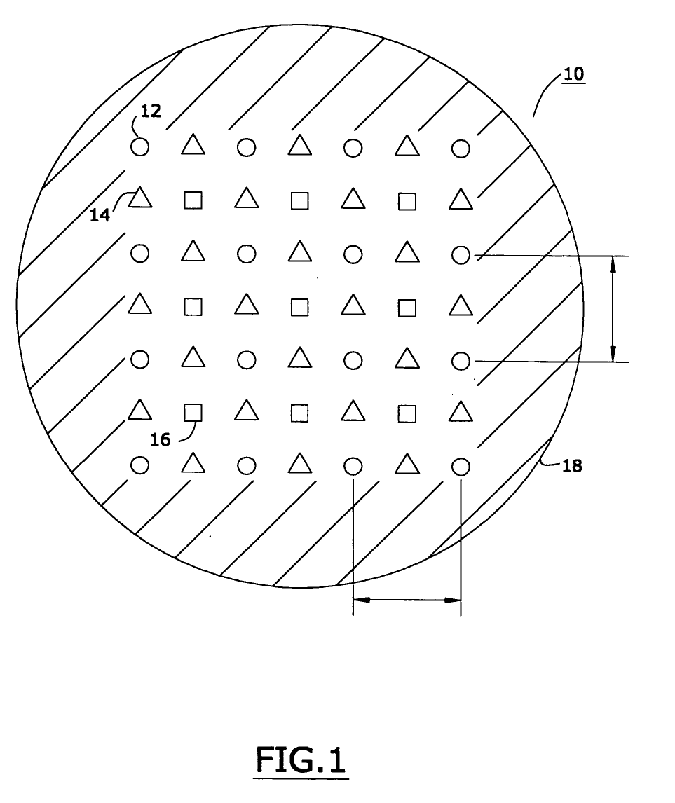

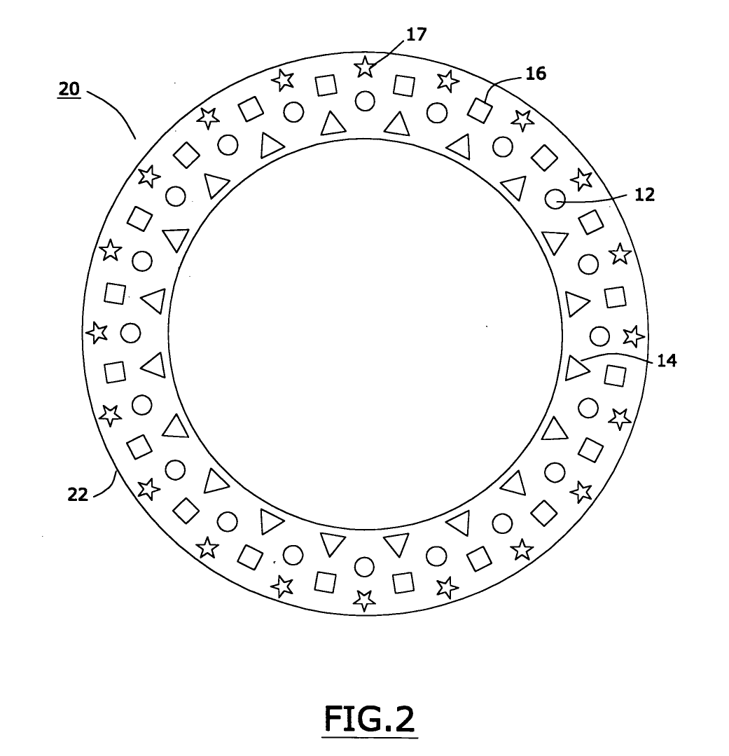

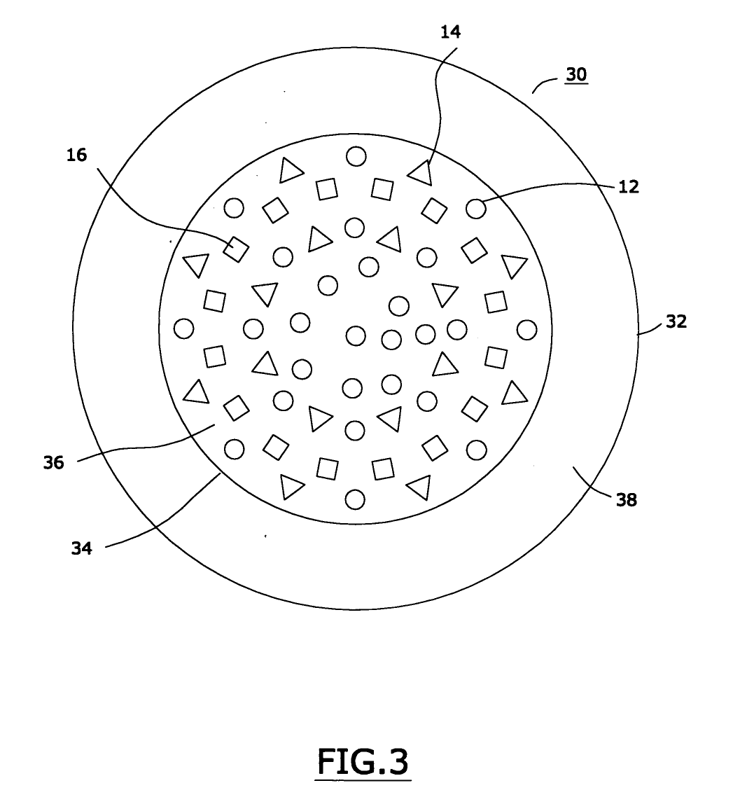

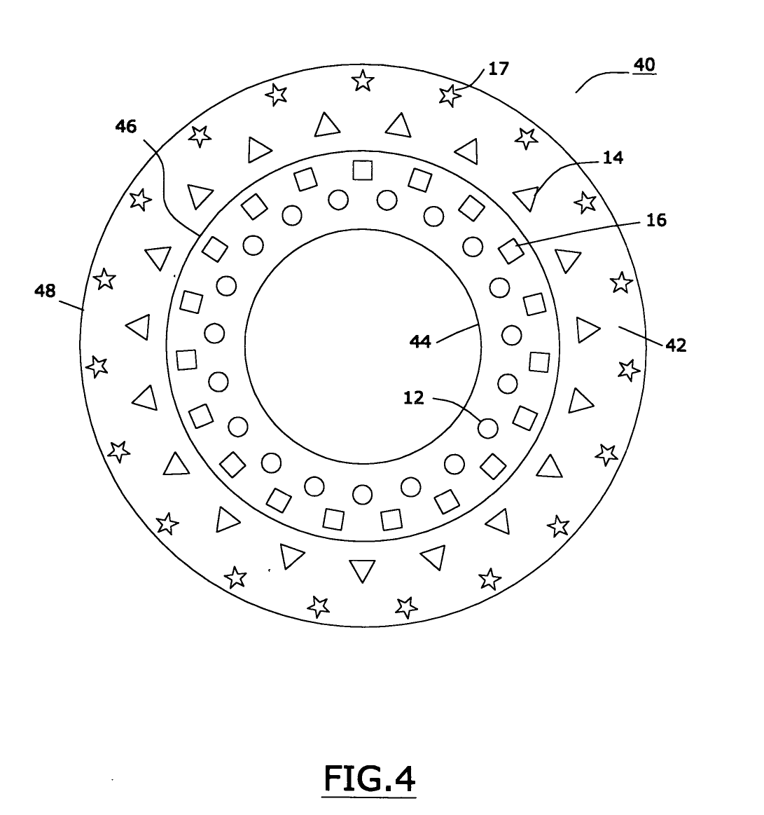

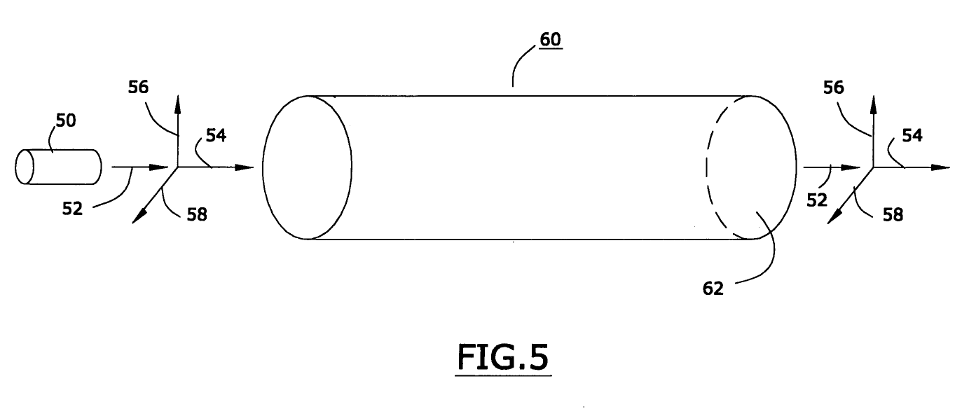

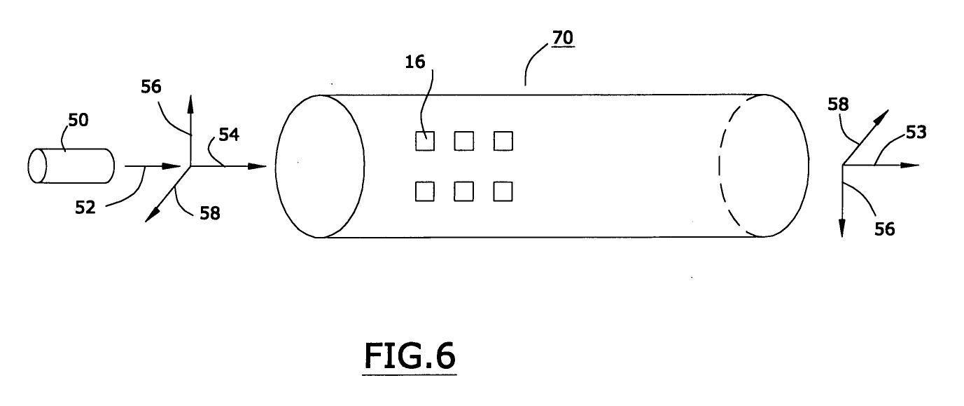

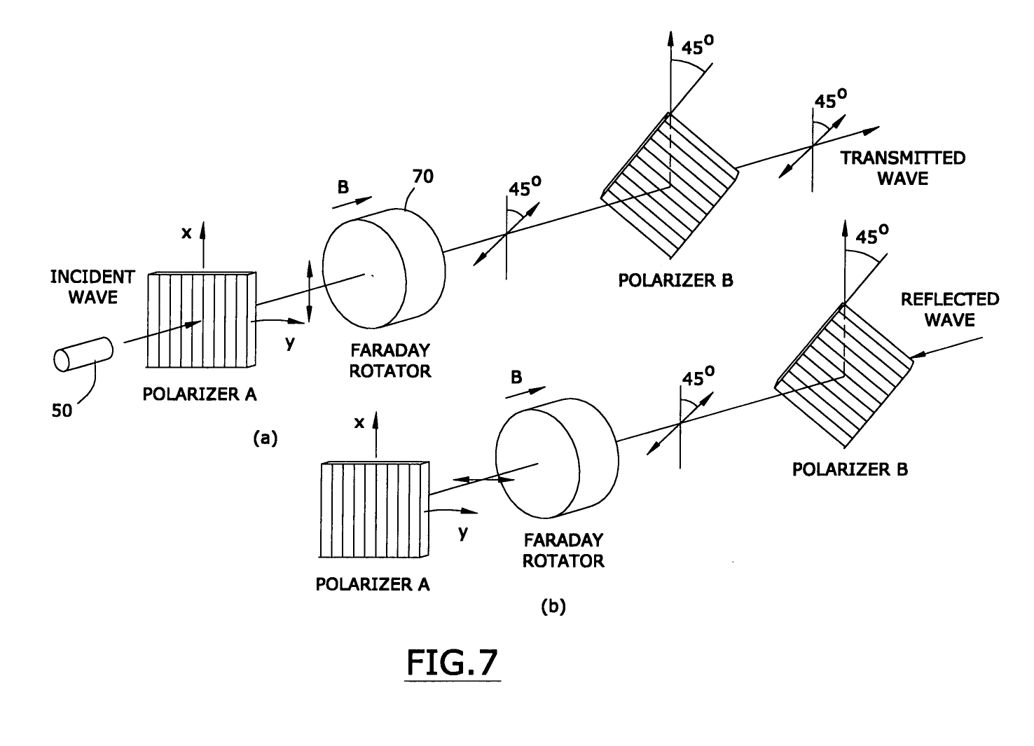

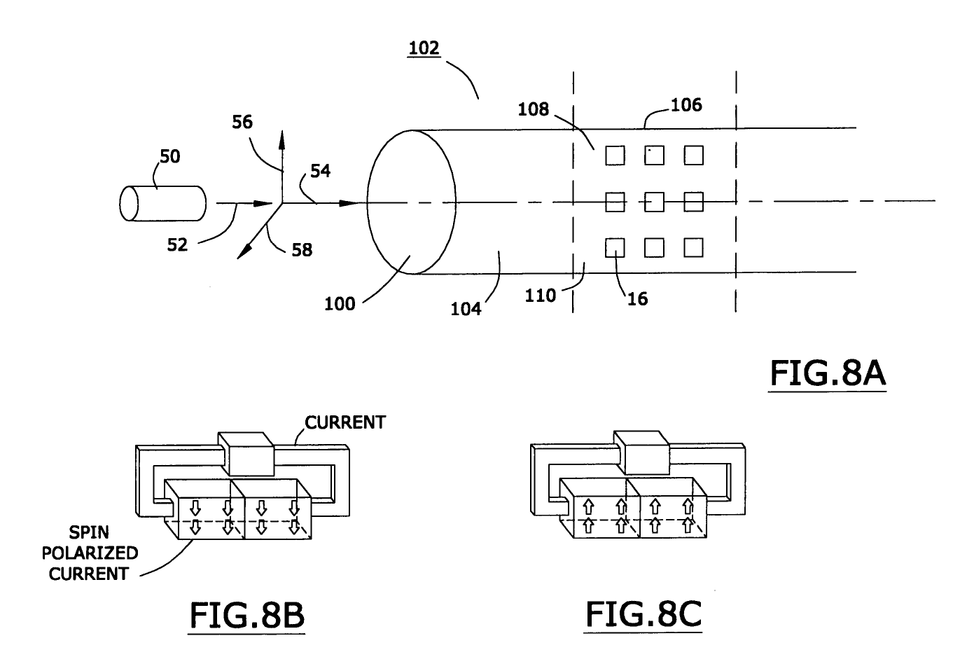

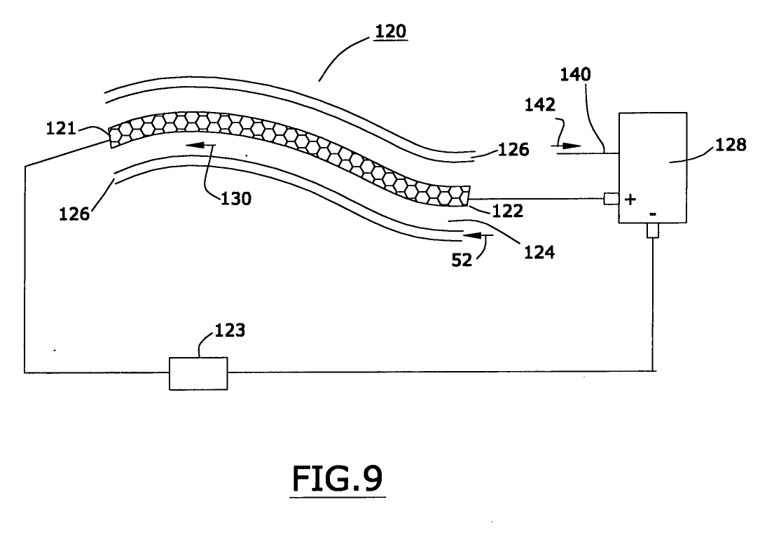

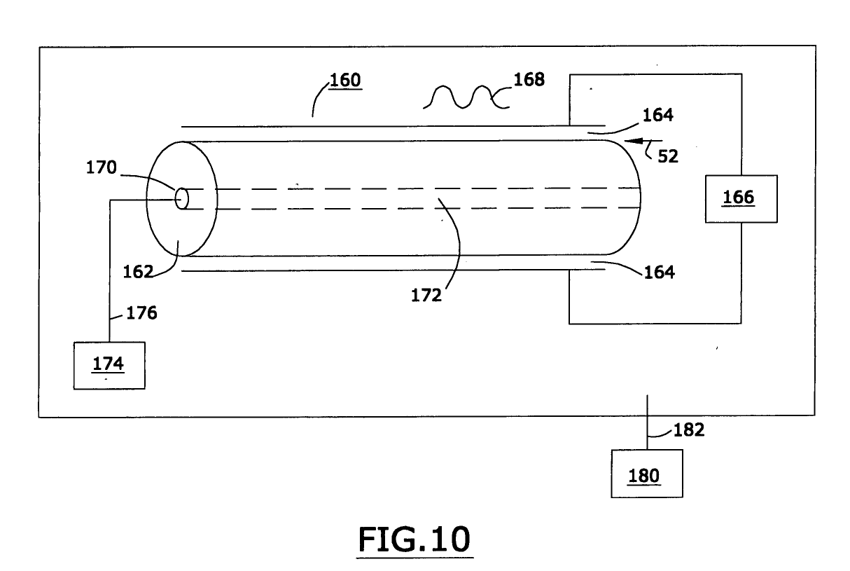

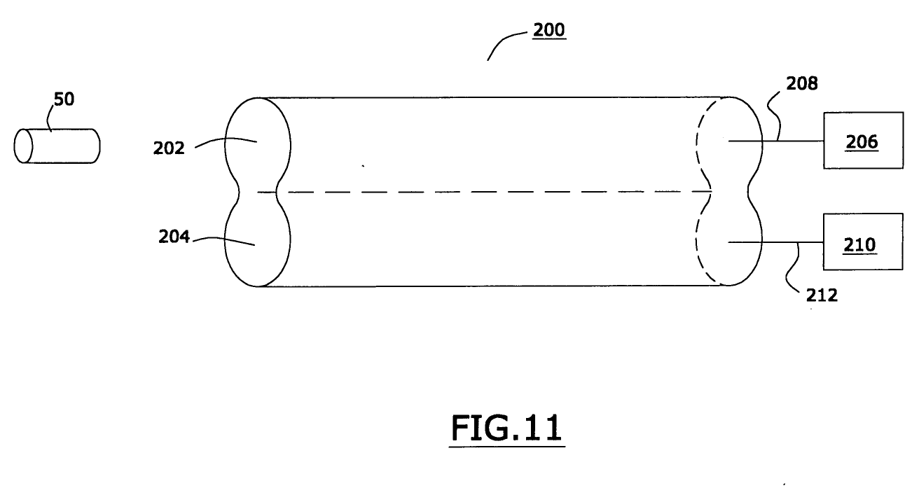

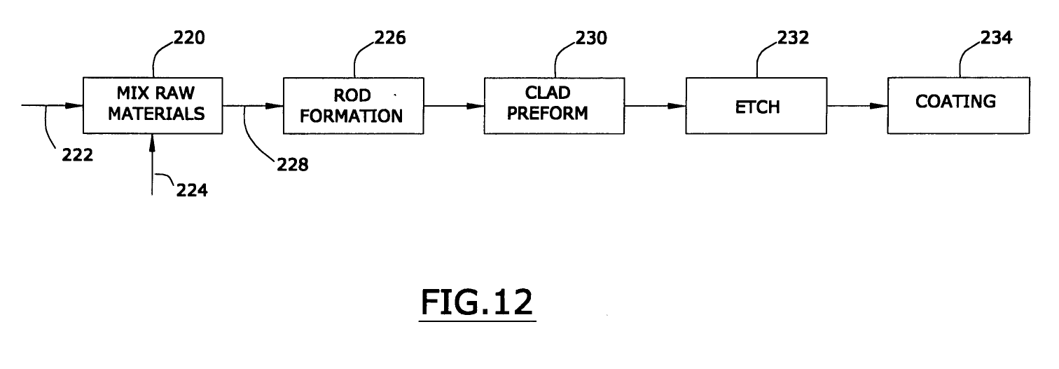

FIG. 1 is a top view of a nanosized cluster 10 that is comprised of nanoparticles with different functionalities. The nanoparticles 12 have optical properties. The nanoparticles 14 have electro-optical properties. The nanoparticles 16 have magnetic properties. The nanoparticles 17 have acoustic properties.

In the preferred embodiment depicted in FIG. 1, the nanosized cluster 10 has a substantially circular-cross sectional shape 18. In one aspect of this embodiment, the nanosized cluster 10 is a fiber 10. In this aspect, for the purposes of simplicity of representation, only the unshaded portion of the fiber 10 is shown as having the nanoparticles 12/14/16/17, it will be apparent that, in this aspect, the entire fiber 10 is preferably comprised of said nanoparticles.

In the preferred nanosized cluster 20 depicted in FIG. 2, the nanoparticles 12/14/16/17 are disposed on the outside surface 22 of the optical fiber 20. In this embodiment, the optical fiber 20 is made from glass (such as, e.g., fused silica), and the nanoparticles 12/14/16 are coated on the exterior surface(s) of such glass fiber.

In the preferred nanosized cluster 30 depicted in FIG. 3, the nanoparticles 12/14/16/17 comprise the core 36 of fiber 30, which is also comprised of sheath 38.

In the preferred nanosized cluster 40 depicted in FIG. 4, a hollow fiber 40 is depicted with a sheath 42 and a hollow center 44. In this embodiment, the nanosized particles 12/14/16/17 are disposed on both the inner and outer surfaces, 46 and 48 respectively, of the fiber 40. In another embodiment, not shown, the nanosized particles 12/14/16/17 are disposed only on the inner surface 46. In yet another embodiment, not shown, such nanosized particles 12/14/16/17 are disposed only on the outer surface 48.

The nanosized clusters depicted in FIGS. 1, 2, and 3 generally have a maximum dimension (such as, e.g., their diameters) of from about 2 to about 200 micrometers, nanometers. In one embodiment, the maximum dimension of the nanosized clusters is from about 10 to about 100 micrometers.

The naanoparticles 12/14/16/17 generally have a maximum dimension of from about 1 to about 500 nanometers. In one embodiment, such nanoparticles have a maximum dimension of from about 10 to about 100 nanometers.

One may utilize any of the optical nanoparticles disclosed in the art. Reference may be had, e.g., to U.S. Pat. No. 6,329,058 (nanosized transparent metal oxide particles, such as titanium oxide), U.S. Pat. No. 5,777,776 (nanosized pigment particles), U.S. Pat. No. 6,190,731 (nanosized metallic ink particles), U.S. Pat. No. 5,434,878 (nanosized optical scattering particles, such as titania and alumina), U.S. Pat. No. 5,023,139 (nanosized sheath/core optical particles), and the like. The entire disclosure of each of these United States patents is hereby incorporated by reference into this specification.

In one embodiment, the optical nanoparticles 12 comprise or consist essentially of titanium oxide. In another embodiment, the optical nanoparticles 12 comprise or consist essentially of one or more of the oxides of tantalum. In another embodiment, the optical nanoparticles 12 comprise or consist essentially of silica.

The optical nanoparticle(s) 12 can function to transmit light, disperse light, diffract light, and/or reflect light. In one embodiment, the optical nanoparticles will have an index of refraction of from about 1.2 to about 10, and preferably from about 2 to about 3.

The optical nanoparticles, unlike the other nanoparticles, require no energy besides light to perform their function(s).

Referring again to FIG. 1, one may use any of the electro-optical nanoparticles known to those skilled in the art. Reference may be had, e.g., to a text by B. E. A. Saleh et al. entitled “Fundamentals of Photonics (John Wiley & Sons, Inc., New York, N.Y., 1991). Referring to Chapter 15 of such book, the electro-optical nanoparticles may be used as semiconducting materials. Referring to Chapter 16 of such book, the electro-optical nanoparticles may be used as light-emitting devices. Referring to Chapter 17 of such book, the electroptical nanoparticles may be used as photon detectors. Referring to Chapter 18 of such book the electrooptical nanoparticles may be used as electrooptical materials such as, e.g., photorefractive materials.

Similarly, one may use any of the nanoparticles known to those skilled in the art that have acoustic properties. Thus, e.g., referring to Chapter 20 of such Saleh et al. text, the nanoparticles may have acousto-otpical properties wherein the particles are used to change the interaction between sound and light.

In another embodiment, one may use nanoparticles that exhibit the surface acoustic wave (SAW) phenomenon. As is known to those skilled in the art, particles possessing this property, when subjected to electrical energy, generate a surface wave of sound energy. Reference may be had, e.g., to U.S. Pat. Nos. 6,323,577, 6,310,425, 6,310,424, 6,310423, 6,291,924, 6,275,123, and the like. The entire disclosure of each of these United States patents is hereby incorporated by reference into this specification.

One may use any of the magnetic nanoparticles known to those skilled in the art. Thus, e.g., reference may be had to U.S. Pat. Nos. 5,741,435, 6,262,949 (magneto-optical nanosized particles), U.S. Pat. No. 6,251,474 (nanosized ferrite particles), and the like. In one aspect of this emobidment, the nanosized particles exhibit the magentooptical effect.

The magnetooptical effect is well known to those skilled in the art and is described, e.g., in the aforementioned Saleh text; see, e.g., pages 225 through 227 of such text. This effect, which is also often referred to as the Faraday effect, involves the fact that certain materials act as polarization rotators when placed in a static magnetic field. The angle of rotation is proportional to various factors, such as the magnetic flux density. Yttrium-iron-garnet particles (YIG), terbium-gallium-garnet particles (TGG), terbium, aluminum-garnet particles (TbAIG), and other material exhibit this effect.

Applicants have described nanoparticles with optical, mangetic, electrooptical, and acoustic properties in conjunction with this invention. This has been done merely for the sake of illustration; it will be appreciated that nanoparticles with other properties also may be used in conjunction with his invention. Thus, e.g., nanopartices with piezoelectric, electrostrictive, thermoelectric, giant-magneto, electromagneto, and other effects also may be used.

One may custom design the property or properties desired in the nanoparticle or nanoparticles to be used in the optical fiber. Thus, via the process of this invention, one may deposit specified amounts of specified nanoparticles with specified properties to achieve any function or combination of functions desired.

Preparation of the Preferred Coated Optical Fiber

In one preferred embodiment, illustrated in FIGS. 1, 2, 3, and 4, the preferred nanoparticle cluster assembly is an coated optical fiber comprised of two or more of the nanoparticles 12, 14, 16, and 17. These coated optical fibers can be prepared by means well known to those skilled in the art.

In one embodiment, an optical fiber is used as a substrate, the substrate is coated with one or more-coating materials comprising the desired nanoparticle(s). In this embodiment, it is preferred that the optical fiber to be coated have certain specified properties.

The optical fiber substrate preferably has a low loss. As is known to those skilled in the art, fiber loss is energy loss per unit length. Thus, e.g., silica fibers have a fiber loss of 0.5 decibels per kilometer of length. Reference may be had, e.g., to U.S. Pat. No. 6,219,176, the entire disclosure of which is hereby incorporated by reference into this specification. This patent discloses, e.g., that “ . . . in recent years, a manufacturing technique and using technique for a low-loss (e.g., 0.2 dB/km) optical fiber have been established, and an optical communication system using the optical fiber as a transmission line has been put to practical use. Further, to compensate for losses in the optical fiber and thereby allow long-haul transmission, the use of an optical amplifier for amplifying signal light has been proposed or put to practical use.” The use of an optical fiber substrate with a fiber loss of less than about 0.2 decibels per kilometer is preferred in the process of this invention.

The optical fiber substrate used in the process of this invention has a preferably low dispersion property. In general, the dispersion of the fiber is such that its bit rate x its length exceeds 100 (gigabits/second)-kilometer. Reference may be had, e.g., to U.S. Pat. Nos. 6,292,601, 6,061,483, and the like. The entire disclosure of each of these United States patents is hereby incorporated by reference into this specification.

The optical fiber substrate used in the process of this invention can either be a single-mode fiber, or a multi-mode fiber. For implantable device applications, where light is used to transfer energy, multi-mode fibers are preferred. For communication applications, a single mode optical fiber is preferred.

In single mode fiber applications, a polarized light source is preferred. One such device is illustrated in FIG. 5.

Referring to FIG. 5, a light source 50 generates a light beam 52 which, as is well known to those skilled in the art, has a propration direction in the direction of arrow 54, an electrical field in the direction of arrow 56, and a magnetic field in the direction of arrow 58. This light beam 52 passes through the center of single mode optical fiber 60.

If single mode optical fiber 60 is homogeneous, without any dielectrical or magnetic properties with the exception of light bending, then light beam 52 exits the distal end 62 of optical fiber 60 substantially unchanged. However, if single mode optical fiber 60 is not homogeneous, and contains nanoparticles 12, 14, 16, and/or 17, then the light beam 52 will be substantially changed.

FIG. 6 illustrates what happens to the light beam 52 when it passes through a single mode optical fiber 70 comprised of nanomagnetic particles 16. In the embodiment depicted in FIG. 6, for the sake of simplicity of representation, such nanomagnetic particles 16 have been shown disposed on only a portion of the inside surface of the optical fiber 70.

As will be apparent, the light beam 52 will be affected by the nanomagnetic particles 16 in fiber 70, so that it becomes transformed to light beam 53. The direction of light beam 53 is the same as the direction of light beam 52, but its electrical and magnetic fields have been rotated. Thus, as will be shown more clearly by reference to FIG. 7, the optical fiber 70 acts as an optical isolator.

FIG. 7 is a copy of diagram 6.6-5 from page 234 of the Saleh, in which device 70 (see FIG. 6) has been identified as the preferred Faraday rotator. Referring to such Saleh text, the optical isolator device in question transmits light in only one direction, thus acting as a one-way valve. These optical isolators are useful in preventing reflected light from returning back to the source. Because of the small size of the optical fiber used, optical isolators such as optical isolator 70 may be implanted within a living organism.

FIG. 8 is a schematic of controlled spintronic device. As is disclosed in U.S. Pat. No. 6,249,453, “spintronic devices make use of the electron spin as well as its charge. It is anticipated that spintronics devices will have superior properties compared to their semiconductor counterparts based on reduced power consumption due their inherent nonvolatility, elimination of the initial booting-up of random access memory, rapid switching speed, ease of fabrication, and large number of carriers and good thermal conductivity of metals. Such devices include giant magnetoresistance (GMR) and tunneling magnetoresistance (TMR) structures that consist of ferromagnetic films separated by metallic or insulating layers, respectively. Switching of the magnetization direction of such elementary units is by means of an external magnetic field that is generated by current pulses in electrical leads that are in proximity. A system whereby the magnetization direction is controlled by an applied voltage is discussed at length in U.S. Ser. No. 09/467,808, incorporated herein by reference. Such as system comprises a ferromagnetic device with first and second ferromagnetic layers. The ferromagnetic layers are disposed such that they combine to form an interlayer with exchange coupling. An insulating layer and a spacer layer are located between the ferromagnetic layers. When a direct bias voltage is applied to the interlayer with exchange coupling, the direction of magnetization of the second ferromagnetic layer.” The entire disclosure of this United States patent is hereby incorporated by reference into this specification.

One of the most fundamental spintronic devices is the magnetic tunnel junction; reference may be had, e.g., to U.S. Pat. Nos. 6,269,018, 6,097,625, 6,023,395, 6,226,160, 6,114,719, and the like. The entire disclosure of each of these United States patents is hereby incorporated by reference into this specification.

As is known to those skilled in the art, the magnetic tunnel junction is just two layers of ferromagnetic material separated by a magnetic barrier. When the spin orientation of the electrons in the two ferromagnetic layers are the same, a voltage is quite likely the pressure the electrons to tunnel through the barrier, resulting in high current flow. But flipping the spins in one of the two layers, so that the two layers have oppositely aligned spins, restricts the flow of current. See, e.g., page 33 of the December, 2001 issue of I.E.E.E. Spectrum (published by the Institute of Electrical and Electronics Engineers, New York, N.Y.).

FIG. 8 illustrates a device 90 for flipping the spin of the material within device 90, thereby affecting its current flow properties. Referring to FIG. 8, and in the preferred embodiment depicted therein, light beam 52 from light source 50 enters the proximal end 100 of optical fiber 102. As it travels the light delivery region 104 of fiber 102, its magnetic polarization properties are unaffected. However, when it travels through spintronic region 106, it flips the spin of the nanomagnetic particles 16 disposed within such region; and it simultaneously aligns the spin of the electrons flowing through spintronic section 106 (see FIGS. 8b and 8c, from said IEEE Spectrum article).

Referring again to FIG. 8, optical fiber 102, in addition to containing magnetic nanoparticles 16, also contains a coating of semiconductive material. In the top half 108 of the optical fiber, gallium arsenide semiconductive material (not shown) is coated on the inside surface of the optical fiber 102. In the bottom half 110 of the optical fiber 102, zinc selenide is coated on the inside surface of the optical fiber 102. The travel of the light beam 52 through the fiber 102 affects the spins of both of electrons in each of these semiconductive materials.

If the spins of the electrons within the gallium arsenide material and the spins of the electrons within the zinc selenide material are aligned, current flow through the fiber device 102 will be large. If, however, the spins of the electrons within the two materials are not aligned, current flow will be restricted. Thus, by choosing the type of semiconductive materials, and the type of magnetic nanoparticles 16, one can either reduce or increase current flow through the device, in addition to the transmission of the light 52.

In another embodiment, not shown, one may apply an external magnetic field in addition to the magnetic nanoparticles 16.

FIG. 9 is a schematic of a device 10 that is comprised of a core of nanoparticles that may, e.g., be electrical nanoparticles 122. The electrical nanoparticles 122 are chosen to have a high electrical conductivity.

Disposed around core 121 is a first sheath 124 of material that conducts heat but not electricity. Such first sheath 124 may comprise or consist essentially of, e.g., aluminum nitride.

Disposed about first sheath 124 is a second sheath 126, which may be made of glass fiber.

As will be apparent to those skilled in the art, when device 120 is implanted in a living organism, it will transmit electricity internally but not pass any such electricity or heat to its external surroundings within the organism. The aluminum nitride prevents the transmission of electricity from core 121 to such surroundings. The heat transmitted from such core 121 to the aluminum nitride first sheath may be dissipated in heat sink 128, to which the aluminum nitride is operatively connected. In one embodiment, heat sink 128 is a battery, which forms a circuit with core 121 and load 123. The heat is conducted via line 140, along the direction 142. The current flows in the direction of arrow 130.

Referring again to FIG. 9, and in one preferred embodiment, in addition to electricity being transmitted through the device in the direction of arrow, light from light beam 52 may simultaneously be transmitted through the glass portion of the assembly.

FIG. 10 is a schematic view of a SAW (surface acoustic wave) device 160. Device 160 is comprised of core 162 of glass which is covered by sheath 164. In the embodiment depicted, for the purposes of simplicity of representation, sheath 164 is shown only partially enclosing core 162. In most embodiments, it is preferred that the sheath 164 entirely enclose core 162.

The sheath 164 is preferably of a material selected from the group consisting of piezoelectric material, electrostrictive material, and mixtures thereof. When voltage is supplied from power supply 166 to sheath 164, the material in sheath 164 mechanically deforms, causing a change in the configuration of its surface. The change in configuration will preferably travel down the length of the sheath 164 in the form of a wave 1168.

As will be apparent to those skilled in the art, because of the small size of the optical fibers used, the assembly 160 may be disposed within a living organism and be used to stimulate such organism.

In one embodiment, in addition to providing such mechanical stimulation, the device 160 may also provide light (from light beam 52) via light port 170. In addition, the device also may provide electrical stimulation through conductor 172.

In the embodiment depicted in FIG. 10, conductor 172 is connected to transducer 174 via line 176, which may convert some or all of the electrical current into sound, light, magnetic energy, and the like. In addition, transducer 174 may act as a power supply to convert the electrical energy into electrical pulses, which may be used to stimulate a heart.

In the embodiment depicted, the device 160 is connected to a controller 180, via line 182. The controller 180 is preferably connected to one or more of the organs of the living organism; and, thus, it can modify the output of device 160 depending upon the need of such organ(s), to deliver one or more of mechanical stimulation, light energy, electrical energy, acoustic energy, and the like.

FIG. 11 depicts a device 200 which is similar to the device 160 but contains two substantially parallel assemblies 202 and 204. Each of devices 202 and 204 is similar to the device 160, with the exception that device 202 is adapted to transmit light to target 206, via line 208; and device 204 is adapted to transmit either electrical energy and/or transduced electrical energy to target 210 via line 212. As will be apparent, the separation of the conductor 172 from chamber 202 facilitates the transmission of light.

A Preferred Process for Making the Devices of This Invention

FIG. 12 is a flow diagram illustrating one preferred process of the invention. Referring to FIG. 12, and in the preferred embodiment depicted therein, in step 220 raw materials are charged to a mixer via line 222. The raw materials will be mixed in a stoichiometry so that the desired end product(s) will be produced.

In one embodiment, in addition to the desired raw material(s), one also charges liquid to mixer 220 via line 224. It is preferred to charge sufficient liquid so that one produces a solution and/or a slurry with a solids content of from about 5 to about 60 weight percent.

In step 226, the slurry from step 220 is transferred via line 228 to a furnace, in which a rod is formed from the slurry. This rod, which is often referred to as a “cylindrical preform,” may be formed by conventional means. Reference may be had, e.g., to U.S. Pat. Nos. 4,199,337, 4,224,046 (optical fiber preform), U.S. Pat. No. 4,682,294 (optical fiber preform), and the like. The entire disclosure of each of these United States patents is hereby incorporated by reference into this specification. One may also refer to pages 65-67 of G. P. Agrawal's “Fiber-Optic Communication Systems” (John Wiley and Sons, Inc., New York, N.Y., 1997) for the process for preparing such a fiber preform.

Once the preform has been produced, in step 230 the preform is clad with a coating of nanoparticles. One may clad such preform by conventional coating means. Thus, by way of illustration and not limitation, one may use the MCVD (modified chemical vapor deposition), OVD (outside vapor deposition), and/or vapor-axial deposition (VAD). Reference may be had, e.g., to page 66 of such Agrawal text. Reference may also be had to United States patents discussing such MCVD technique (see U.S. Pat. Nos. 6,015,396, 6,122,935, 5,397,372, 4,389,230, 6,131,413), such OVD technique (see U.S. Pat. No. 6,295,843), and/or said VAD technique (see U.S. Pat. Nos. 6,131,415, 4,801,322, 5,281,248, and the like). The entire disclosure of each of these United States patents is hereby incorporated by reference into this specification.

In such step 232 of the process, one may etch the clad fiber. As is known to those skilled in the art, one may conduct such etching by chemical, mechanical, or lithographic means. See, e.g., U.S. Pat. No. 6,285,127 (etched glass spacer), U.S. Pat. No. 6,281,136 (etched glass), U.S. Pat. Nos. 6,105,852, 6,071,374, and the like. The entire disclosure of each of these United States patents is hereby incorporated by reference into this specification.

As will be apparent, the function of the etching step 232 is to form a one or more specified grooves or indentations in the optical fiber and/or the cladding. As will be apparent, by the judicious use of masking, one may etch only selected portions of the substrate.

In step 234, the etched substrate is optionally coated with one or more additional coating materials. Such additional coatings may be applied by conventional means such as, e.g., chemical vapor deposition, plasma activated chemical vapor deposition, physical vapor deposition, ion implantation, sputtering, ion plating, plasma polymerization, laser deposition, electron beam deposition, molecular beam chemical vapor deposition, plasma deposition, and the like. Reference may be had to H. K. Pulker's “Coating on Glass” (Elsevier, Amsterdam, The Netherlands, 1999).

In one embodiment, chemical vapor deposition is used in step 234. This technique is very well known. Reference may be had, e.g. to U.S. Pat. Nos. 4,561,871, 5,338,328, 5,296,011, 4,528,009, 4,206,968, and the like. The entire disclosure of each of these United States patents is hereby incorporated by reference into this specification.

In another embodiment, plasma coating is used. Reference may be had to U.S. Pat. No. 5,540,959, the entire disclosure of which is hereby incorporated by reference into this specification. This patent claims a process for preparing a coated substrate in which mist particles are created from a dilute liquid, the mist particles are contacted with a pressurized carrier gas and contacted with radio frequency energy while being heated to form a vapor, and the vapor is then deposited onto a substrate. The coated substrate is then preferably heated.

It is to be understood that the aforementioned description is illustrative only and that changes can be made in the apparatus, in the ingredients and their proportions, and in the sequence of combinations and process steps, as well as in other aspects of the invention discussed herein, without departing from the scope of the invention as defined in the following claims.

1. A fiber assembly comprised of nanoparticles, wherein said nanoparticles are a mixture of nanomagnetic particles and nanooptical particles.
